(19) United States
(12) Patent Application Publication
(10) Pub. No.: US 2004/0145574 A1
(43) Pub. Date: Jul. 29, 2004

(54) Invoking applications by scribing an indicium on a touch screen

(76) Inventors: Zhen Li Xin, Shanghai (CN); Huang Jian Cheng, Shanghai (CN)

Correspondence Address: MOTOROLA INC, 600 NORTH US HIGHWAY 45, ROOM AS437, LIBERTYVILLE, IL, 60048-5343, US

(21) Appl. No.: 10/353,406

(22) Filed: Jan. 29, 2003

(51) Int. Cl. G09G 5/00

(52) U.S. Cl. 345/173

(57) ABSTRACT

An electronic device (1) and method (20) for invoking an application on the electronic device (1). The method (20) includes determining (24) if an indicium scribed on a touch screen (5) of the device (1) identifies a device application. A step of effecting (28) then invokes the device application if the indicium identifies the application regardless of what application was displayed on the touch screen (5) when the indicium was being scribed.

### FIELD OF THE INVENTION

This invention relates to invoking applications on an electronic device. The invention is particularly useful for, but not necessarily limited to, invoking applications on a portable electronic device with a touch screen.

### BACKGROUND ART

Cellular telephones, Personal Digital Assistants (PDAs) and other similar portable electronic devices, and electronic devices in general, sometimes have a touch screen display as a two-way user interface for data entry, invoking applications and menu traversing. Typically, such touch screens usually require a user to point to functions or input data by the use of a stylus. In US patent issued under U.S. Pat. No. 5,612,719 there is described an electronic device with a touch screen for displaying a gesture sensitive button displayed on the screen. The button is responsive to at least two different button gestures including a tap gesture and a more complex gesture. Upon the detection of a gesture, the device will invoke a designated application that is dependent upon which button gesture is detected. However, the selected applications are menu dependent and therefore the menu identifying an application must be displayed on the screen before it can be selected.

Other electronic devices that have touch screens also have the limitation of requiring applications to be displayed on a menu, or by icon identifiers, before they can be selected. Accordingly, some prior art electronic devices with touch screens using pull-down hierarchical menus require inconvenient and time-consuming menu traversing when selecting applications.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided a method for invoking an application on an electronic device, the method including the steps of:

determining if at least one indicium scribed on a touch screen of said device identifies an application of said device; and

effecting said application if said indicium identifies said application regardless of what application was displayed on said touch screen when said indicium was being scribed thereon.

Suitably, the step of determining may be further characterized by distinguishing between a scribed said indicium and point contact applied to said touch screen.

Preferably, step of determining may be further characterized by said indicium being associated with a telephone number and upon said indicium being scribed on said touch screen, said number is automatically called by said portable telephone.

Preferably, method may be further characterized by providing for menu or icon selection by said point contact applied to said touch screen.

Suitably, the step of determining may include a step of normailizing said indicium. Preferably, said normalizing may include scaling to provide a converted copy of the indicium. Suitably, the step of determining may include a template matching test step to determine if the converted copy matches a template of indicium that are linked to applications of the device.

Preferably, the method may be further characterized by the templates being pre-programmed. The templates may be suitably defined by a user.

According to another aspect of the invention there is provided an electronic device comprising:

a processor; and

a touch screen coupled to said processor,

wherein, in use, when at least one indicium is scribed on said touch screen said processor effects a recognition process, and if said indicium identifies an application of said device, said application is effected by said device regardless of what application was displayed on said touch screen when said indicium was being scribed thereon.

Suitably, said device may be further characterized by said processor being able to determine between a scribed indicia and point contact applied to said touch screen.

Suitably, said electronic device may be a portable telephone.

Preferably, said indicium may be associated with a telephone number and upon said indicium being scribed on said touch screen, said number is automatically called by said portable telephone.

Preferably, the processor in use may provide for menu or icon selection by said point contact applied to said touch screen.

### BRIEF DESCRIPTION OF THE DRAWINGS

In order that the invention may be readily understood and put into practical effect, reference will now be made to a preferred embodiment as illustrated with reference to the accompanying drawings in which:

FIG. 1 is a block diagram illustrating an embodiment of an electronic device in accordance with the invention;

FIG. 2 is a flow diagram illustrating a method for invoking an application on the electronic device of FIG. 1;

FIG. 3 is a flow diagram illustrating a step of determining that forms part of the method of FIG. 2;

FIG. 4 is a flow diagram illustrating a method for allowing a user to create and store an indicium for use in the method of FIG. 2;

FIG. 5 illustrates a touch screen of the device of FIG. 1 displaying icons and an indicium scribed on the touch screen; and

FIG. 6 illustrates the touch screen of FIG. 5 after the indicium has been processed by the method of FIG. 2.

### DETAILED DESCRIPTION OF THE PREFERRED EMBODIMENT OF THE INVENTION

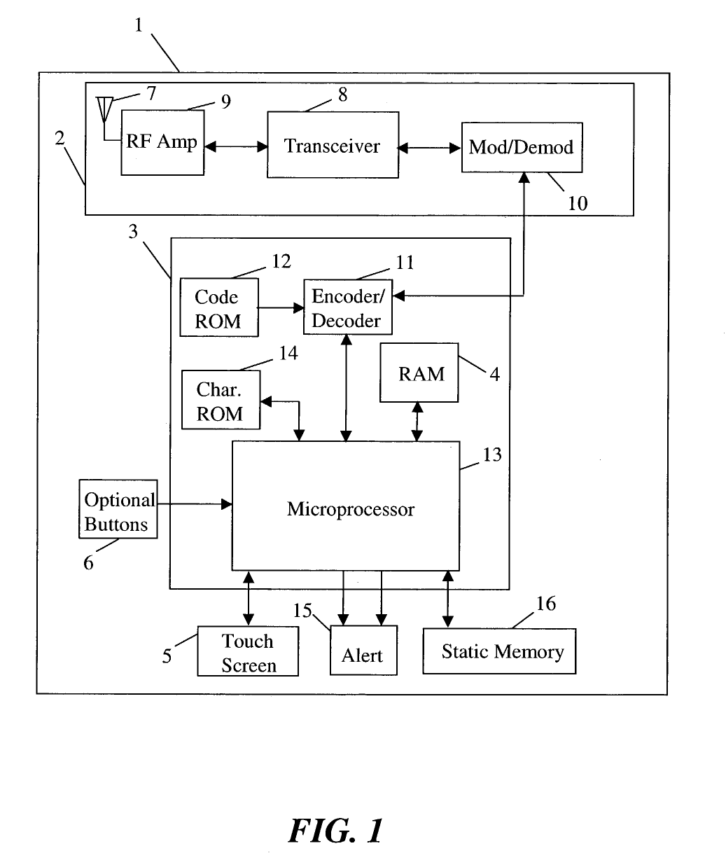

In the drawings, like numerals on different Figs are used to indicate like elements throughout. With reference to FIG. 1, there is illustrated an electronic device 1 comprising a radio frequency communications unit 2 coupled to be in communication with a processor 3. A touch screen 5 and optional buttons 6 are also coupled to be in communication with the processor 3.

The processor 3 includes an encoder/decoder 11 with an associated Read Only Memory 12 storing data for encoding and decoding voice or other signals that may be transmitted or received by electronic device 1. The processor 3 also includes a micro-processor 13 coupled to both an encoder/decoder 11 and an associated character Read Only Memory 14. Micro-processor 13 is also coupled to a Random Access Memory 4, the optional buttons 6, the touch screen 5 and a static programmable memory 16. As will be apparent to a person skilled in the art, the touch screen 5 has an incorporated driver that is controllable by micro-processor 13. The touch screen 5 is two-way user interface for typically allowing data entry, invoking device applications and commands, menu traversing, displaying text, displaying graphics and displaying menus. Data entry, and other user input requirements, to the touch screen 5 is typically by use of a stylus as will be apparent to a person skilled in the art.

Auxiliary outputs of micro-processor 13 are coupled to an alert module 15 that typically contains a speaker, vibrator motor and associated drivers. The character Read only memory 14 stores code for decoding or encoding text messages that may be received by the communication unit 2, input at the touch screen 5 or input at the optional buttons 6. In this embodiment the character Read Only Memory 14 also stores operating code (OC) for micro-processor 13. The operating code (OC) is used to run applications on the electronic device 1.

The radio frequency communications unit 2 is a combined receiver and transmitter having a common antenna 7. The communications unit 2 has a transceiver 8 coupled to antenna 7 via a radio frequency amplifier 9. The transceiver 8 is also coupled to a combined modulator/demodulator 10 that couples the communications unit 2 to the processor 3.

The electronic device 1 can be any electronic device including a cellular telephone, a conventional type telephone, a laptop computer or a PDA. If the electronic device 1 is a cellular telephone, a user can select an application by traversing menus, or selecting icons, displayed on the touch screen 5. For instance, one application is that of accepting a telephone call in response to a received calling signal received by the radio frequency communications unit 2 in which the calling signal, transmitted from a transmission source, is received by antenna 7 and then amplified by amplifier 9, filtered by transceiver 8 and demodulated by the modulator/demodulator 10. The Encoder/Decoder 11 in combination with associated Read Only Memory 12 is used, for instance, to decode the calling signal and identify the caller's identity. The micro-processor 13, Random Access memory 4 and Read Only Memory 14 then process the received calling signal and sends a control signal to the alert module 15. This therefore alerts the user that the electronic device 1 is being called. The user then has the option of accepting the call, in which the identity of the calling party is typically displayed on the touch screen 5, by simply actuating a soft key displayed on the touch screen 5.

Instead of a telephone call, the electronic device 1 may receive an email message with an attachment such as a spreadsheet or picture each having different color scale resolutions. In another mode of operation, the cellular telephone 1 may process and display a received message that may be in the form of part of a networked conference with a very high color scale resolution. In yet other modes of operation, the user can select an application by actuation of soft keys, icons or by traversing a menu on the touch screen 5. Such applications may be accessing or creating spreadsheets, word processing, importing and viewing high or low color resolution graphics, sending and receiving short messages, Internet browsing, viewing an address book and making a telephone call. Accordingly, as will be apparent to a person skilled in the art, the electronic device 1 may be a 2.5G or 3G cellular telephone.

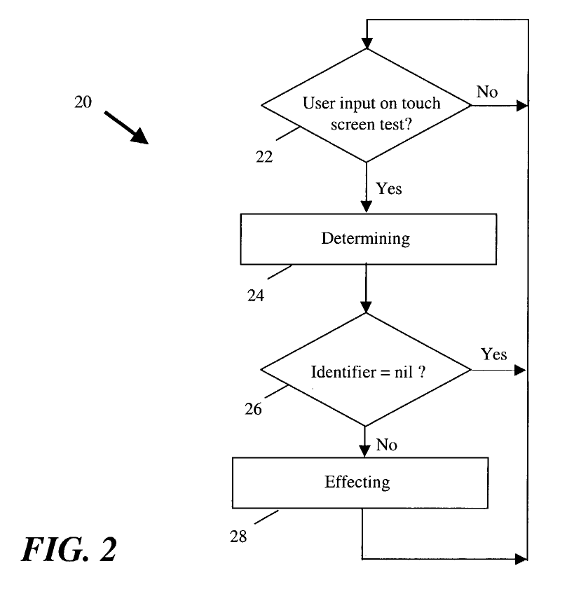

In addition to the above, the electronic device 1 allows for applications to be requested and invoked by scribing indicium on the touch screen 5. In this regard, referring to FIG. 2 there is illustrated a method 20 for invoking an application on the electronic device 1 in which at a test step 22 a signal is sent to the processor 3 when a user inputs a point contact (touch) or line contact (scribe) on the touch screen 5. When such a signal is sent by the touch screen 5, a determining step 24 determines if at least one indicium scribed on a touch screen 5 identifies an application of the device 1. The determining step 24 also distinguishes between a scribe and point contact (touch). If instead of a scribe, a point contact (touch) is applied to the touch screen 5, a user may have selected an application via use of menu or icon selection displayed on the touch screen 5 or alternatively an invalid or accidental point contact may have occured. Accordingly, the determining step 24 will set an identifier to either nil or to a requested application (as described below).

At an identifier test step 26, the processor 3 checks if the identifier is set to nil, implying no application was requested and the input to the touch screen 5 was a data entry, an invalid entry or accidental. If the identifier is nil then the method 20 returns to the test step 22, otherwise a step of effecting the application 28 is conducted. If the identifier is set due to a scribe identifying an indicium, the step of effecting the requested application 28 will effect the requested application. This will occur only if the indicium identifies the application regardless of what application was displayed on the touch screen 5 when the indicium was being scribed. After step 28, the method 20 returns to the test step 22.

From the above method 20, it will be apparent that when an indicium is scribed on the touch screen 5, the processor 3 essentially effects a recognition process. If the indicium identifies an application of the device 1, the application is effected regardless of what application was displayed on the touch screen 5 when the indicium was being scribed.

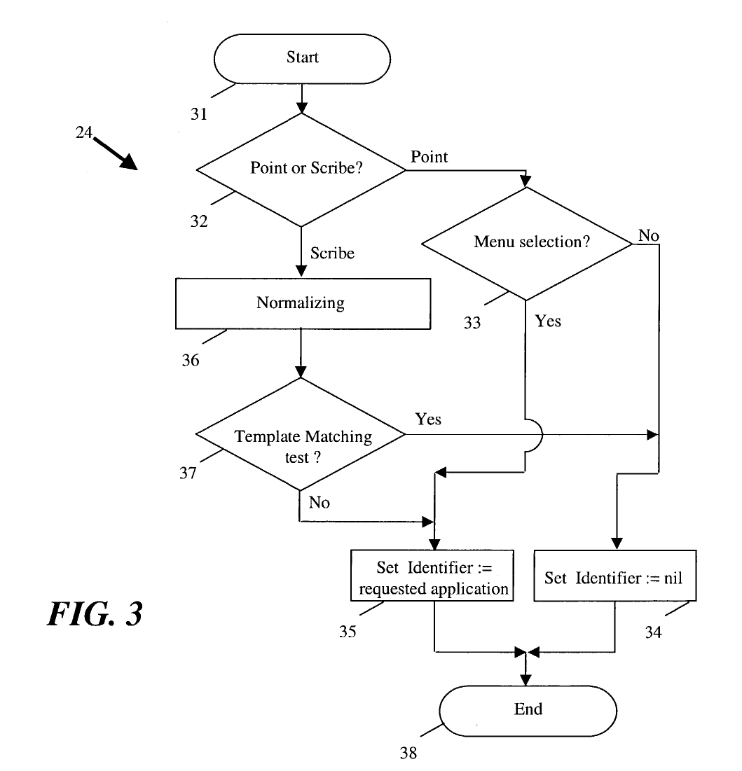

The determining step 24 is described in more detail with reference to FIG. 3. After a start step 31, a point or scribe test step 32 determines if either a user has pointed a stylus at the touch screen 5 or scribed an indicium comprising one or more lines. If it is determined that a point touch (tap) has been applied to the touch screen 5, then a menu selection test step 33 checks to determine if a device application has been selected by use of icons or a menu displayed on the touch screen 5. If no device application was determined as selected then a set step 34 sets the Identifier to nil as it is presumed the input to the touch screen 5 was accidental or erroneous. Alternatively, if a device application was determined to be selected then a set step 35 sets the Identifier to the requested application identified by the selected icon or a menu. After step 34 or 35, the step of determining 24 ends at an end step 38.

If the point or scribe test step 32 determines that the user has scribed indicia comprising one or more lines on the touch screen 5, then a normalizing step 36 is effected. The normalizing step 36 normalizes the indicium input on the touch screen 5 by storing a converted copy that is converted so that it is confined within a pre-defied rectangular boundary. Thus, normalization involves scaling and then a template matching test step 37 is effected to determine if the converted copy matches a template of an indicium stored in the static programmable memory 16. If there is a match determined test step 37, then the identifier is set at the set step 35 to be a requested application linked (i.e. programmed to be associated) with the matched indicium in the static programmable memory 16. Alternatively, if there is no match at test step 36, then the set step 34 sets the Identifier to nil and the step of determining 24 ends at step 38. In view of the above, it will be apparent that the determining step 24 distinguishes between scribed indicium and point contact on the touch screen 5 and thereafter sets the identifier.

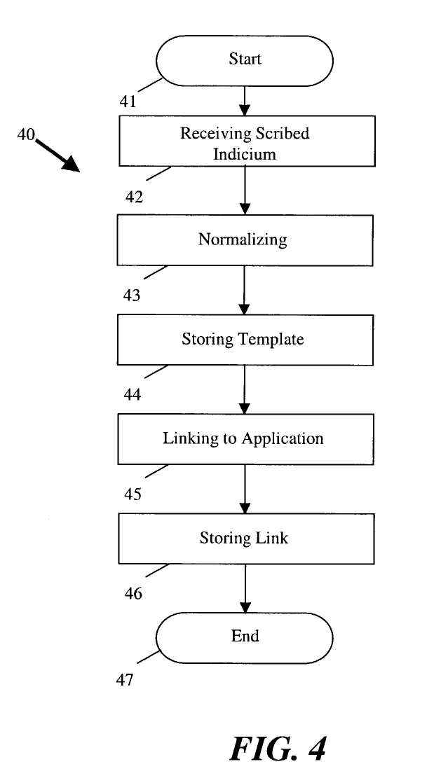

The templates for indicia stored in the static programmable memory 16 and their associated links to device applications may be pre-programmed by the manufacturer or supplier of the electronic device 1. Alternatively, or additionally, the templates may be defined, stored in the memory 16 and linked to a device application by the user. This is achieved by referring to FIG. 4 which illustrates a method 40 for allowing a user to create, and store in the memory 16, a template of an indicium and link the stored template to a device application. In the method 40, a user provides an input command to the touch screen 5 to effect a start step 41 after which the user scribes an indicium on the touch screen 5. The scribed indicium is received by the processor 3 at a receiving scribed indicium step 42. A step of normalizing 43 then converts a copy of the scribed indicium so that it is confined within a pre-defied rectangular boundary. Thus, the step of normalizing 43 involves scaling to provide a template and thereafter a storing template step 44 in memory 16 is effected. The user then provides an input command or commands, by appropriate selection of icons or menus on the touch screen 5, in order to effect a linking to application step 45 in which the template is linked to an application of the device 1. The application and template link is then stored in memory 16 at a storing link step 46 and the method 40 ends at and end step 47.

Advantageously, when indicium is scribed on the touch screen 5, the processor 3 determines if the indicium identifies a requested application of the device 1. The application is effected by the device 1 regardless of what application was displayed on the touch screen 5 when the indicium was being scribed. The present invention therefore advantageously allows for a user to scribe a pre-defined indicium on the touch screen 5. This indicium, if matched to a template, invokes a linked application without the need of the user to traverse a menu. Accordingly, the invention provides a simple and rapid selection of applications.

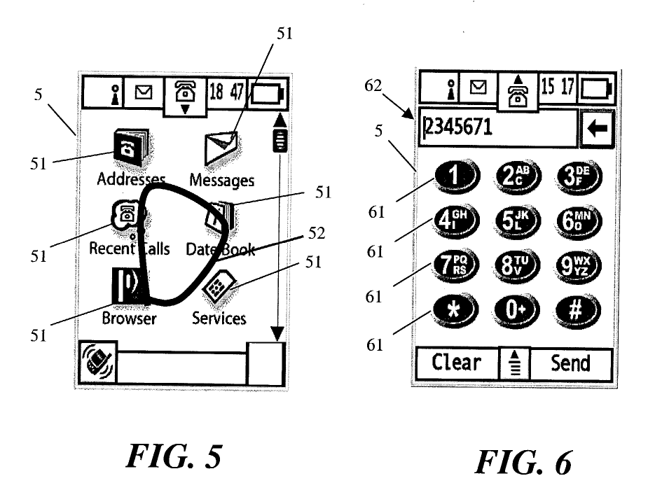

As shown in FIG. 5, the touch screen 5 is displaying icons 51 associated with applications of the device 1. These applications include, for example, an address book, a message folder, recent call listings, a datebook, an Internet browser and services such as news group subscriptions. When an indicium 52 is scribed on the touch screen 51 (in this example the letter “D”) the method 20 is effected and if the indicium 52 matches a template in the memory 16, then the application linked to the matching template is invoked. For example, if the scribed indicium 52 is matched to a template linked to an application “dial a telephone number”, then the touch screen 5 will display a stet of dialing buttons 61, illustrated in FIG. 6, and the application “dial a telephone number” will be invoked. As shown, the scribed indicium is associated with a specific telephone number 62 and upon the indicium being scribed on the touch screen 5, the number 62 is automatically dialed by the device 1 which in this example is portable telephone.

The detailed description provides a preferred exemplary embodiment only, and is not intended to limit the scope, applicability, or configuration of the invention. Rather, the detailed description of the preferred exemplary embodiment provides those skilled in the art with an enabling description for implementing a preferred exemplary embodiment of the invention. It should be understood that various changes may be made in the function and arrangement of elements without departing from the spirit and scope of the invention as set forth in the appended claims.

We claim:

1. A method for invoking an application on an electronic device, the method including the steps of:
determining if at least one indicium scribed on a touch screen of said device identifies an application of said device; and
effecting said application if said indicium identifies said application regardless of what application was displayed on said touch screen when said indicium was being scribed thereon.

2. A method for invoking an application on an electronic device as claimed in claim 1, wherein the step of determining is further characterized by distinguishing between a scribed said indicium and point contact applied to said touch screen.

3. A method for invoking an application on an electronic device as claimed in claim 2, wherein step of determining is further characterized by said indicium being associated with a telephone number and upon said indicium being scribed on said touch screen, said number is automatically called by said portable telephone.

4. A method for invoking an application on an electronic device as claimed in claim 3, wherein method is further characterized by providing for menu or icon selection by said point contact applied to said touch screen.

5. A method for invoking an application on an electronic device as claimed in claim 1, wherein the step of determining includes a step of normailizing said indicium.

6. A method for invoking an application on an electronic device as claimed in claim 5, wherein said normalizing includes scaling to provide a converted copy of the indicium.

7. A method for invoking an application on an electronic device as claimed in claim 6, wherein the step of determining includes a template matching test step to determine if the converted copy matches a template of indicium that are linked to applications of the device.

8. A method for invoking an application on an electronic device as claimed in claim 7, wherein the method is further characterized by the templates being pre-programmed.

9. A method for invoking an application on an electronic device as claimed in claim 7, wherein the templates are suitably defined by a user.

10. An electronic device comprising:
a processor; and
a touch screen coupled to said processor,
wherein, in use, when at least one indicium is scribed on said touch screen said processor effects a recognition process, and if said indicium identifies an application of said device, said application is effected by said device regardless of what application was displayed on said touch screen when said indicium was being scribed thereon.

11. An electronic device as claimed in claim 10 further characterized by said processor being able to determine between a scribed indicia and point contact applied to said touch screen.

12. An electronic device as claimed in claim 10, wherein said electronic device is a portable telephone.

13. An electronic device as claimed in claim 10, wherein said processor in use provides for menu or icon selection by said point contact applied to said touch screen.

14. An electronic device as claimed in claim 11, wherein said processor in use provides for menu or icon selection by said point contact applied to said touch screen.
